(19) United States
(12) Patent Application Publication
(10) Pub. No.: US 2017/0003493 A1
(43) Pub. Date: Jan. 5, 2017

(54) ENDOSCOPE OBJECTIVE, METHOD FOR CLEANING AN ENDOSCOPE OBJECTIVE AND FOR REPAIRING AN ENDOSCOPE

(71) Applicant: OLYMPUS WINTER & IBE GMBH, Hamburg (DE)

(72) Inventor: Jianxin ZHAO, Hamburg (DE)

(73) Assignee: OLYMPUS WINTER & IBE GMBH, Hamburg (DE)

(21) Appl. No.: 15/268,554

(22) Filed: Sep. 17, 2016

Related U.S. Application Data
(63) Continuation of application No. PCT/EP2015/055440, filed on Mar. 16, 2015.

(30) Foreign Application Priority Data
Mar. 21, 2014 (DE) 10 2014 205 312.9

(51) Int. Cl. G02B 23/24; G02B 27/00; G02B 7/02

(52) U.S. Cl. CPC G02B 23/243; G02B 7/021; G02B 27/0006; G02B 23/2476

(57) ABSTRACT

An endoscope objective including: an objective tube having an interior: a distal lens assembly disposed in a distal portion in the interior of the objective tube; a proximal lens assembly disposed in a proximal portion in the interior of the objective tube; a stop provided between the distal lens assembly and the proximal lens assembly at an inner side of the objective tube such that an outer distal surface of the proximal lens assembly abuts a proximal side of the stop and an outer proximal surface of the distal lens assembly abuts a distal side of the stop to form an intermediate space between the outer distal surface of the proximal lens assembly and the outer proximal surface of the distal lens assembly; and at least one access opening extending through the stop and connecting an outer lateral surface of the objective tube to the intermediate space.

### CROSS-REFERENCE TO RELATED APPLICATION

The present application is a continuation of PCT/EP2015/055440 filed on Mar. 16, 2015, which is based upon and claims the benefit to DE 10 2014 205 312.9 filed on Mar. 21, 2014, the entire contents of each of which are incorporated herein by reference.

### BACKGROUND

Field

The present application relates to an endoscope objective, comprising an objective tube, in the interior of which a distal lens assembly and a proximal lens assembly are disposed one behind the other in a longitudinal axial direction, wherein a stop, which is between the distal lens assembly and the proximal lens assembly, is present at an inner side of the objective tube, wherein an outer distal surface of the proximal lens assembly abuts a proximal side of the stop and an outer proximal surface of the distal lens assembly abuts a distal side of the stop, wherein there is an intermediate space between the outer distal surface of the proximal lens assembly and the outer proximal surface of the distal lens assembly.

Furthermore, the present application relates to an endoscope, comprising an endoscope objective, as well as to a method for cleaning an endoscope objective and for repairing an endoscope.

Prior Art

Endoscope objectives typically are in the end of each region of an endoscope and, in general, are disposed behind a protective window. The field in front of the distal end of the endoscope is observed with the help of the endoscope objective. For a video endoscope, the endoscope objective images the surroundings on an image sensor. For flexible endoscopes, the image can be formed on a flexible bundle of optical fibers.

Usually, an endoscope objective is constructed from several groups of lenses. In particular, it is customary that one or more distal groups of lenses and proximal groups of lenses are provided, which are disposed one behind the other in a longitudinal, axial direction of the endoscope objective.

DE 10 2008 038 619 B3 discloses an endoscope objective with three groups of lenses, which are taken up with circumferential clearance in an objective tube. This comprises an inner flange, which acts as a stop. The proximal lens assembly abuts distally this stop, whereas the distal lens assembly abuts proximally the stop. This construction counteracts a possible tilting of the lens assembly, so that a high optical imaging quality of the endoscope objective is assured.

The individual lenses of a lens assembly usually are glued over their whole surface. On the other hand, when the individual groups of lenses are assembled to form the endoscope objective, a closed space is formed within the objective after the assembly. It cannot be excluded that contamination, such as fuzz or dust, collects in this space. Furthermore, there may be parts of the interior blackening of the objective tube or slight chippings from the edges of the lenses in such a closed space, inner space or intermediate space.

Under some circumstances, such contamination decreases the optical quality of the endoscope objective. The only possibility remaining to remove the contamination is, if possible, to disassemble the endoscope objective and, after cleaning it, to assemble it once again. In some cases, it is unavoidable to discard endoscope objectives, which do not meet the required quality standards.

### SUMMARY

It is an object to provide an endoscope objective, an endoscope, a method for cleaning an endoscope objective and for repairing an endoscope, wherein the quality of the endoscope objective or of the endoscope is to be improved and its manufacture is to be more economic.

Such objective can be solved by an endoscope objective, comprising an objective tube, in the interior of which a distal group of lenses and a proximal lens assembly are disposed one behind the other in a longitudinal axial direction, wherein, at one inner side of the objective tube, there is a stop, which is between the distal lens assembly and the proximal lens assembly, wherein an outer, distal surface of the proximal lens assembly abuts a proximal side of the stop and an outer proximal surface of the distal lens assembly abuts a distal side of the stop, wherein, between the outer distal surface of the proximal lens assembly and the outer proximal surface of the distal lens assembly, there is an intermediate space, wherein the endoscope objective can be developed further in that there is at least one access opening, which, starting out from an outer lateral surface of the objective tube, extends through the stop and ends in the intermediate space.

By creating an access opening in the region of the stop, the possibility is created of removing contamination, which is present in this region of the endoscope objective, from an otherwise inaccessible interior. This measure can increase the optical quality of the endoscope objective. Furthermore, the number of endoscope objectives, which has to be discarded during manufacture or maintenance because of an unacceptable optical quality, is reduced.

In the context of the present specification, a distal lens assembly is understood to be especially a lens assembly, which comprises further subgroups of lenses. If, for example, the three groups of lenses are provided for the endoscope objective, for example, an outer distal lens assembly, a central lens assembly and a proximal lens assembly, then the outer distal lens assembly and the central lens assembly together are referred to as the distal lens assembly. For an endoscope objective, which has three groups of lenses, the stop can be between the central and the proximal lens assembly.

Furthermore, in the context of the present specification, an outer surface of a lens assembly is always understood to be the outer surface of the outer lens of the lens assembly in question. For example, the outer distal surface of the proximal lens assembly is the outer distal surface of the outer distal lens of the proximal lens assembly. Correspondingly, an outer proximal surface of the distal lens assembly is the outer proximal surface of the outer proximal lens of the distal lens assembly.

The access opening can be closed reversibly or irreversibly. For example, the access opening can be closed reversibly with the help of a grub screw, which optionally is sealed additionally, with a sealing compound. The access opening can be closed irreversibly, for example, with an adhesive or a cement.

A diameter of the access opening can be smaller than a dimension of the stop in the longitudinal axial direction of the objective tube. For example, the diameters selected is so large, that on both sides of the access opening, between the surface of the access opening and a distal a proximal stop surface, a sufficiently large material thickness is present, so that the stop is mechanically stable enough in order to fulfill the task assigned to it.

In accordance with an embodiment, the at least one access opening extends perpendicularly to a longitudinal direction in which the objective tube extends. In accordance with a further development of the endoscope objective, the at least one access opening can be a borehole, which extends radially to a central longitudinal axis of the objective tube.

An access opening, which is perpendicular to the direction of the longitudinal extent of the objective tube, can represent the shortest way from the surface of the objective tube into the intermediate space. An effective and simple access to the intermediate space is provided in this way. The material, removed for producing the access opening, is minimal.

In accordance with a further embodiment, an outer distal surface of the proximal lens assembly and/or an outer proximal surface of the distal lens assembly can be concave.

As far as their effect on the optical imaging quality of the objective is concerned, concave lens surfaces frequently are very sensitive to contamination. In many endoscope objectives, the beam diameter of the beam path is comparatively small on these surfaces. Consequently, contamination has a clear effect on the optical imaging quality of the endoscope objective. The possibility of cleaning such a surface therefore can have a very positive effect on the quality of the endoscope objective.

Furthermore, in accordance with a further development, a first access opening and a second access opening can be present. Providing two access openings can improve access to the intermediate space. Furthermore, it becomes possible to clean the intermediate space in various ways.

The first access opening and the second access opening can be disposed opposite to one another at the objective tube.

Viewed in a cross-section through the objective tube, which is perpendicular to a longitudinal axial direction of the objective tube, access openings, opposite to one another, can have a maximum distance in this plane from one another. In other words, the two access openings and a longitudinal axis of the objective tube can lie on a common straight line extending in this cross sectional plane.

A first access opening and a second access opening, moreover, can permit the intermediate spaces to be rinsed or blown out with the help of a cleaning medium, such as nitrogen as well as dried and/or purified air.

Such object can be further solved by an endoscope, comprising an endoscope channel, in which an endoscope objective of one or more of the embodiments mentioned is disposed.

Such object can be further solved by a method for cleaning an endoscope objective of one or more of the embodiments mentioned, wherein the method comprises the steps of:

a) providing the endoscope objective, and

b) cleaning the intermediate space, the outer distal surface of the proximal lens assembly and/or the outer proximal surface of the distal lens assembly, wherein the cleaning is carried out with a cleaning apparatus for accessing the intermediate space over one or more openings.

The intermediate space can be cleaned after the distal lens assembly and the proximal lens assembly have been fixed in the objective tube. Furthermore, the access opening can be closed irreversibly, for example, by using an adhesive or a cement.

The method can be used for the manufacture and/or maintenance of endoscopes objectives or endoscopes.

The cleaning can be carried out with a cleaning apparatus, which can comprise a needle-shaped front end section, which is provided for removing contamination, wherein the end section is introduced into the inner space through the access opening, a working space being maintained.

Furthermore the needle-shaped front end section of the cleaning apparatus can be charged electrostatically.

In accordance with a further embodiment, the needle-shaped front end section of the cleaning apparatus can be a compressed air nozzle or a suction nozzle having a suction channel, the air channel being acted upon by compressed air and the suction channel by a vacuum.

The object can also be solved by a method for repairing an endoscope, comprising the steps of:

a) providing an endoscope, comprising an endoscope objective of one or more of the aforementioned embodiments,

b) removing the endoscope objective,

c) cleaning the endoscope objective with a method according to one or more of the aforementioned embodiments, and

d) assembling the endoscope.

The advantages of the method for cleaning an endoscope objective are similar or like the advantages, which have already been mentioned with respect to the endoscope objective or with respect to the device for cleaning the endoscope objective.

Further features will become evident from the description of the embodiments, together with the claims and the attached drawings. Embodiments may fulfill individual features or a combination of several features.

### BRIEF DESCRIPTION OF THE DRAWINGS

The embodiments are described below by means of examples with reference to the drawings without limiting the scope or spirit of the claims; with respect to all embodiments, which are not described in greater detail in the text, reference is made explicitly to the drawings, of which:

FIG. 1 illustrates a device for cleaning an endoscope objective in a diagrammatic longitudinal section;

FIG. 2 illustrates a diagrammatic longitudinal section of an endoscope objective; and

FIG. 3 illustrates an endoscope in a diagrammatic, perspective view.

Identical or similar elements and/or parts in the drawings are provided with the same reference numbers, so that a repeated introduction is avoided.

### DETAILED DESCRIPTION

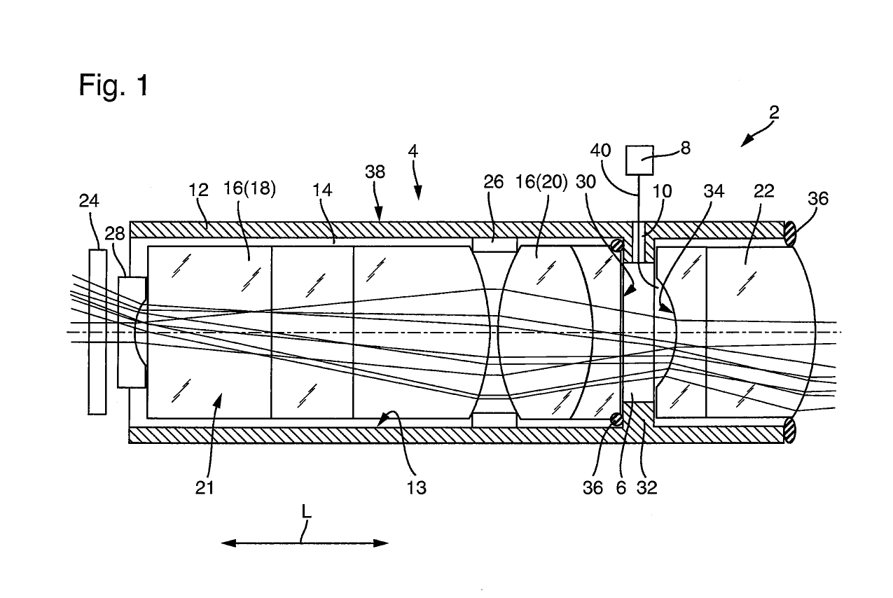

FIG. 1 shows a diagrammatic longitudinal section of a device 2 for cleaning an intermediate space 6 in the interior of an endoscope objective 4. For this purpose, a cleaning apparatus 8 accesses the intermediate space 6 by way of an access opening 10.

The endoscope objective 4 comprises an objective tube 12, which extends in a longitudinal axial direction L. It is essentially cylindrical and can have a circular cross-section, when viewed in a plane perpendicular to the longitudinal axial direction L. The longitudinal axial direction L can be oriented parallel to a central longitudinal axis (not shown) of the objective tube 12. A distal lens assembly 16 and a proximal lens assembly 22 are disposed in an interior space 14 of the objective tube 12. According to the embodiment shown, the distal lens assembly 16 comprises two subgroups of lenses. It can consist of an outer distal lens assembly 18 and a central lens assembly 20.

Distally of the outer distal groups of lenses 18, there is an entry window 24, which closes the endoscope, not shown in FIG. 1, at the distal front surface. The region in front of the distal end of the endoscope is observed through the entry window 24. Objects, present in this area, will be imaged by the endoscope objective 4 on an image sensor, which is not shown, or on a bundle of optical fibers. The optical image is shown diagrammatically by means of the light beam 21, drawn in different line types and passing through the endoscope objective 4. If the endoscope is a video endoscope, the optical image is formed on an image sensor, such as a CCD or CMOS chip. In the case of a flexible endoscope, the image is formed on a flexible bundle of optical fibers. The optically sensitive region of the image sensor or of the fiber bundle is to be found proximally of the proximal lens assembly 22.

For producing the endoscope objective 4, the lens assembly 18, 20, 22 are introduced along the longitudinal axial direction L into the objective tube 12 and disposed one behind the other in the objective tube 12 in the proximal direction. Subsequently, the groups of lenses 18, 20, 22 are fixed in the objective tube 12.

In accordance with the embodiment of FIG. 1, the central lens assembly 20 is brought into the objective tube 12 from the distal end. Subsequently, a covering pipe 26 is pushed into the objective tube 12. The covering pipe 26 is pushed proximally in the longitudinal axial direction L, until it abuts a distal surface of the central lens assembly 20. Subsequently, the outer distal lens assembly 18 is pushed into the objective tube 12 and moved in the longitudinal axial direction L until a proximal surface of the outer distal lens assembly 18 abuts the covering pipe 26. The covering pipe 26 defines a distance in the longitudinal axial direction L between the outer distal lens assembly 18 and the central lens assembly 20. As a result, the distal lens assembly 16 is pushed into the objective tube 12 until the outer proximal surface 30 of the latter abuts a distal side of a stop 32.

Furthermore, a meniscus 28 is provided at a distal end of the endoscope objective 4. Prisms may likewise be provided in order to make a sideways viewing endoscope or endoscope objective 4 available.

The proximal surface 30 of the distal lens assembly 16 abuts a distal side of the stop 32. The distal outer surface 34 of the proximal lens assembly 22 abuts an opposite proximal side of the stop 32. The stop 32 can be in the shape of a flange, which is provided at the inner side 13 of the objective tube 12. The stop 32 can extend completely along the periphery of the objective tube 12 at the inner side 13 thereof. The stop 32 can extend in a plane, which is oriented perpendicularly to a central longitudinal axis of the objective tube 12. However, it is possible for the stop 32 to extend only sectionally along the periphery of the objective tube 12; alternatively, the stop 32 is uninterrupted along the periphery. During the production of the endoscope objective 4, the proximal lens assembly 22 is pushed from the proximal end into the objective tube 12, until the outer distal surface 34 abuts the proximal side of the stop 32.

The distal lens assembly 16 and the proximal lens assembly 22 are fixed in the objective tube 12, for example, by an adhesive 36 along their periphery. The stop 32 requires an intermediate space 6 to be present between the outer distal surface 34 of the proximal lens assembly 22 and the outer proximal surface 30 of the distal lens assembly 16. During the manufacture of the endoscope objective 4, it is possible that contamination, such as dust or lint, abrasion from an internal blacking of the objective tube 12, chippings from the edges of the lenses or the like collect in the intermediate space 6. Such contamination can reduce the optical quality of the endoscope objective 4.

In order to be able to remove contamination from the intermediate space 6 of the endoscope objective 4, the endoscope objective 4 can be provided with an access opening 10.

The access opening 10 starts out from an outer lateral surface 38 of the objective tube 12, extends through the stop 32 and ends in the intermediate space 6. The access opening 10 can extend perpendicularly to a longitudinal direction of the longitudinal axial direction L of the objective tube 12. The access opening 10 can be a borehole, which extends radially to the central longitudinal axis of the objective tube 12, which is not shown only for reasons of clarity.

The device 2 for cleaning an endoscope objective 4, which is shown in FIG. 1, comprises the cleaning apparatus 8, the front end section 40 of which is needle-shaped. The front end section 40 serves for removing contamination and, with respect to its dimensions, especially its diameter and its length, is set up so that, while maintaining a sufficiently large working space, can be introduced through the access opening 10 into the intermediate space 6.

The cleaning can take place with a simultaneous visual control through the distal or proximal entry window of the endoscope objective 4. For example, a person, assigned to the cleaning, can look in the distal or proximal direction through the endoscope objective 4 and holds this during the cleaning, which can further be in front of a bright background. With the help of the cleaning apparatus 8, it is possible to clean the intermediate space 6, such as the outer proximal surface 30 of the distal lens assembly 16 and/or the outer distal surface 34 of the proximal lens assembly 22 and to free these from contamination, which may be present. The cleaning of the optical surfaces can be achieved even where the surface cleaned is a concave optical surface, such as the outer distal surface 34 in FIG. 1. As is indicated by the sketched light beams 21, the beam path extends on the concave surface of the outer distal surface 34 in a small surface region of the lens. Any contamination, present on the surface, therefore brings about a noticeable decrease in the imaging quality of the endoscope objective 4. Thus, the cleaning apparatus 8 is useful to remove contamination in this region.

The cleaning effect can be achieved in various ways, such as, the cleaning apparatus 8 can be configured such that the front end section 40 can be charged electrostatically. Contamination can be attracted electrostatically and taken up in this way and subsequently removed through the access opening 10 from the endoscope objective 4. Furthermore, the cleaning apparatus 8, can be configured such that the needle-shaped front end section 40 of the cleaning apparatus 8 is provided with an air channel or a suction channel. Accordingly, at a free end of the front end section 40, there can be a compressed air nozzle or a suction nozzle, which can be acted upon through the air channel or the suction channel with compressed air or a vacuum. In this way, any contamination can be blown away from the optical surfaces 30, 34 or aspirated or sucked away by the cleaning apparatus 8 and, with that, removed from the intermediate space 6.

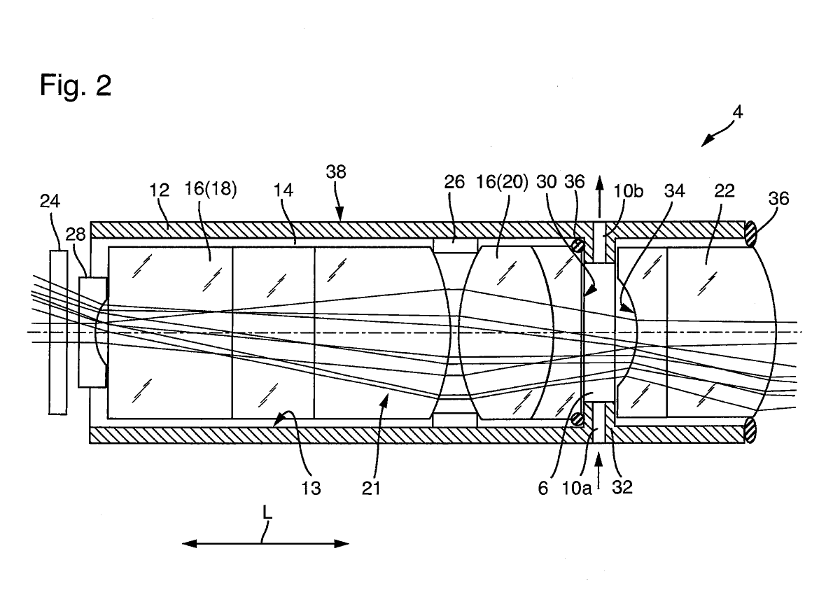

FIG. 2 shows a diagrammatic longitudinal sectional view of an endoscope objective 4. Basically, the construction of the endoscope objective 4 shown in FIG. 2 corresponds to that of the endoscope objective 4 shown in FIG. 1. Deviating from the endoscope objective 4 shown in FIG. 1, the endoscope objective 4, which is shown in FIG. 2, comprises a first access opening 10a and a second access opening 10b.

The first access opening 10a and the second access opening 10b, can also extend, like the access opening 10 shown in FIG. 1, from the outer lateral surface 38 of the objective tube 12 through the stop 32 and end in the intermediate space 6. The first access opening 10a and the second access opening 10b can be disposed opposite to one another at the objective tube 12. The first access opening 10a and the second access opening 10b can lie in a common plane together with the central longitudinal axis of the objective tube 12 such that they have a maximum distance from one another in the peripheral direction of the objective tube 12.

The intermediate space 6 of an endoscope objective 4, which comprises two access openings 10a, 10b, can be flushed with a cleaning medium. In such configuration, it is possible to bring the cleaning medium into the intermediate space 6 through the first access opening 10a and to have it leave again through the second access opening 10b. This process is indicated diagrammatically in FIG. 2 with the help of a first arrow entering access opening 10a and a second arrow leaving access opening 10b.

The cleaning medium may be a gas as well as a liquid. The intermediate space 6 can be flushed with nitrogen or with dried and purified compressed air. Methanol can also be used as a cleaning liquid, since it evaporates without leaving a residue. At the conclusion of a flushing process with the help of a cleaning liquid, the intermediate space 6 can be dried by a subsequent treatment with a gas.

In order to flush the intermediate space 6 with a cleaning medium, the cleaning apparatus can comprise a connecting adapter (not shown), which can be coupled to each of the two access openings 10a, 10b. The connecting adapter can be configured so as to not penetrate into the intermediate space 6. Each of the cleaning adapters can have a fluid channel, which communicates with the access openings 10a, 10b in the connected state of the connecting adapters.

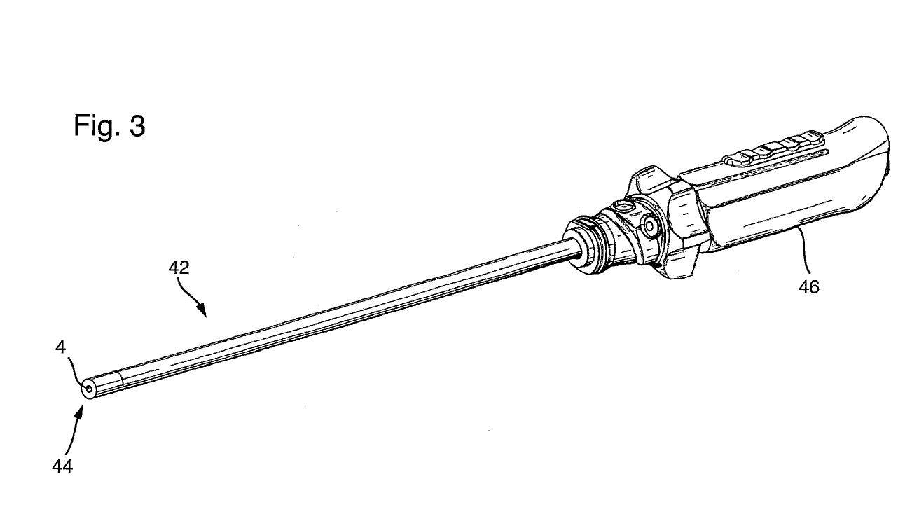

FIG. 3 shows an endoscope 42, which can be configured as a rigid endoscope, at the distal end 44 of which there is an endoscope objective 4. The endoscope objective 4 can be disposed behind an entry window, which is not shown. A proximal end of the endoscope 42 comprises a handle 46. A rigid endoscope is shown in FIG. 3 by way of example. The endoscope objective 4 of one or several of the embodiments disclosed herein can be used just as well for flexible endoscopes.

The possibility of cleaning an intermediate space 6 created by the access opening 10 can have a positive effect not only on the achievable optical quality of the endoscope objective 4; it can also lead to an increase in efficiency during the manufacture of the endoscope objective 4.

Initially, for cleaning an endoscope objective 4, the distal lens assembly 16 and the proximal lens assembly 22 are positioned in the interior space 14 of the objective tube 12. Subsequently, the lens groups 16, 22 are fixed in the objective tube 12 by appropriate gluing 36.

In order to remove contamination, which has penetrated into the space of the objective tube 12 during the manufacturing process, from the intermediate space 6, the intermediate space 6 is cleaned after the lens assembly 16, 22 has been fixed. Aside from the intermediate space 6 itself, especially the outer distal surface 34 of the proximal lens assembly 22 as well as the outer proximal surface 30 of the distal lens assembly 16 are cleaned. The cleaning is carried out optionally and depending on the type of endoscope objective 4 produced either over a single access opening 10, for example, with the cleaning apparatus, 8, or by rinsing the intermediate space 6 using the first and second access openings 10a, 10b.

After the cleaning, the access opening or openings 10, 10a, 10b are closed reversibly or irreversibly. The access openings 10, 10a, 10b can be closed, with a grub screw screwed into the access opening or openings 10, 10a, 10b. Furthermore, the grub screw can be fixed with a screw adhesive or a different sealant. Alternatively, the access opening or openings 10, 10a, 10b can be closed with an adhesive or a cement.

In each case, identical or similar elements and/or parts have been provided with the same reference numbers in the drawings, so that a repeated introduction is always avoided.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SYMBOLS

2 device
4 endoscope objective
6 intermediate space
8 cleaning apparatus
10 access opening
10a first access opening
10b second access opening
12 objective tube
13 interior side
14 intermediate space
16 distal lens assembly
18 outer distal lens assembly
20 central lens assembly
22 proximal lens assembly
24 protective window
26 covering tube
28 meniscus
30 outer proximal surface
32 stop
34 outer distal surface
36 gluing
38 outer lateral surface
40 front end section
42 endoscope
44 distal end
46 handle
L longitudinal axial direction

What is claimed is:

1. An endoscope objective comprising:
an objective tube having an interior:
a distal lens assembly disposed in a distal portion in the interior of the objective tube;
a proximal lens assembly disposed in a proximal portion in the interior of the objective tube;
a stop provided between the distal lens assembly and the proximal lens assembly at an inner side of the objective tube such that an outer distal surface of the proximal lens assembly abuts a proximal side of the stop and an outer proximal surface of the distal lens assembly abuts a distal side of the stop to form an intermediate space between the outer distal surface of the proximal lens assembly and the outer proximal surface of the distal lens assembly; and
at least one access opening extending through the stop and connecting an outer lateral surface of the objective tube to the intermediate space.

2. The endoscope objective according to claim 1, wherein the at least one access opening extends perpendicularly to a direction of a longitudinal axis of the objective tube.

3. The endoscope objective according to claim 1, wherein the at least one access opening is a borehole, which extends radially to a longitudinal axis of the objective tube.

4. The endoscope objective according to claim 1, wherein one or more of the outer distal surface of the proximal lens assembly and the outer proximal surface of the distal lens assembly are concave.

5. The endoscope objective according to claim 1, wherein the at least one access opening comprises a first access opening and a second axis opening.

6. The endoscope objective according to claim 5, wherein the first access opening and the second access opening are disposed opposite to one another relative to a central longitudinal axis of the objective tube.

7. The endoscope objective according to claim 1, further comprising a means for closing the access opening.

8. The endoscope objective according to claim 7, wherein the means for closing comprises one or more of a threaded screw and a cement.

9. An endoscope comprising:
an endoscope channel; and
an endoscope objective according to claim 1 disposed in the endoscope channel.

10. A method for cleaning an endoscope objective with one or more access openings formed through a stop between an outer distal surface of the proximal lens assembly and an outer proximal surface of the distal lens assembly to form an intermediate space in the endoscope objective, the method comprising:
accessing the intermediate space through the one or more access opening with a cleaning apparatus; and
cleaning one or more of the intermediate space, the outer distal surface of the proximal lens assembly and the outer proximal surface of the distal lens assembly through the one or more access openings with the cleaning apparatus.

11. A method for repairing an endoscope having an endoscope objective with one or more access openings formed through a stop between an outer distal surface of the proximal lens assembly and an outer proximal surface of the distal lens assembly to form an intermediate space in the endoscope objective, the method comprising:
removing the endoscope objective from the endoscope;
accessing the intermediate space through the one or more access opening with a cleaning apparatus;
cleaning one or more of the intermediate space, the outer distal surface of the proximal lens assembly and the outer proximal surface of the distal lens assembly through the one or more access openings with the cleaning apparatus; and
subsequent to the cleaning, assembling the endoscope objective in the endoscope.
